(19) United States
(12) Patent Application Publication
(10) Pub. No.: US 2003/0005311 A1
(43) Pub. Date: Jan. 2, 2003

(54) Sending apparatus, receiving apparatus, use limit system and method of sending contents

(75) Inventors: Toshiyuki Kajimura, Nara (JP); Tomohiko Kitamura, Osaka (JP); Toshiro Nishio, Osaka (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/178,538

(22) Filed: Jun. 25, 2002

(30) Foreign Application Priority Data
Jun. 28, 2001 (JP) 2001-196566

(51) Int. Cl. H04L 9/00

(52) U.S. Cl. 713/186

(57) ABSTRACT

A use limit system in which only contents users who have made a viewing contract can decrypt encrypted contents and use the contents.

Use limit is set on contents on the basis of the physical features of the rightful user. The use limit system is made up of a sending apparatus for sending the contents and a receiving apparatus which removes use limit of contents sent from the sending apparatus by acquiring the physical features of the rightful user of contents.

### BACKGROUND OF THE INVENTION

1. Field of the Invention

The present invention relates to a use limit system limiting the use of contents.

2. Prior Art of the Invention

There are a number of methods of setting use limit on contents such as image data, voice data, etc. Representative of them is a method in which, with contents encrypted, a decryption key is distributed to rightful members.

For example, among the contents received by broadcast-receiver called set stop box are contents encrypted by a method laid down by contents provider (hereinafter “contents agent”). Therefore, when a viewer wants to view such contents, the viewer has to hold a viewing contract with the contents agent to get the decryption key and input the decryption key into the set top box.

Then, the encrypted contents is decrypted by decryption means provided in the set top box and then inputted into the monitor etc. This way, only the user who has made a viewing contract with the contents agent and gets a decryption key can remove use limit on the contents.

Among the methods of the viewer's inputting the decryption key in set top box are a method of inputting a decryption key using operating means such as remote control etc. and a method of the viewer's inserting an integrated circuit (IC) card with a decryption key memorized therein into the set top box

However, when trying to remove the use limit by inputting the decryption key using the above-mentioned operating means, the user can not view the contents if the user forgets the decryption key.

Another problem, if the user loses the IC card with a decryption key memorized therein and a third party steals the key, there is a possibility that the third party will use the contents.

Therefore, the IC card is stealed the outsider, the secret information to be disclosed to only a specific user is included in the contents can leak out to the outsiders.

### SUMMARY OF THE INVENTION

The present invention having been achieved in view of the above circumstances, it is an object of the invention to provide a use limiting system that allows a rightful user alone to use contents by decrypting the ciphertexts of the contents.

To achieve the object, the present invention adopts the following means. Sending apparatus 100 sets a limit on the use of contents so that only specific users can use the contents. That is, sending apparatus 100 sets a use limit permit information of the physical features of the user such as fingerprint, palm print, hand print, voiceprint, pattern of the retina, pattern of the iris, form of the face, and DNA.

To use the contents on which a use limit is set by sending apparatus 100, the use limit has to be removed. The limit is removed by a removal means 125 provided in the receiving apparatus 120.

When a person identified from the physical features set on the use limit of the contents is found identical with a person with the physical features acquired by an acquisition means 128 provided in the receiving apparatus 120, the removal means 125 removes the use limit on the contents.

Using the use limit of the contents and the physical features to remove the use limit of the contents that way solves the problems with the prior art, that is, if the user forgets the decryption key, the user can not use the contents; an IC card with a decryption key memorized therein can be stolen and used by a third party.

The above method of setting use limit can be changed. If the method is changed, the user of contents will have to buy receiving apparatus 120 provided with a function of removing a changed use limit. In case different methods of setting use limit are set on different contents providers or contents', the user will have to buy a plurality of receiving apparatuses 120.

But since the receiving apparatus 120 is provided with a function of receiving contents and another function of removing use limit, the apparatus is expensive, and the economic burden will be heavy on the contents user.

To avoid that, a first apparatus 310 is made to have the receiving function of contents possessed by the receiving apparatus 120, and a third apparatus 330, an apparatus different from receiving means 311, is made to have the removal function of the use limit. Thus, the third apparatus 330 without a receiving function is lower than the receiving apparatus 120 in manufacturing cost.

Therefore, even if the use limit is set on contents in any method, the contents user can use all contents by buying only the third apparatus 330 of the above method, which can reduce the economic burden of the user of contents.

If the third apparatus 330 is used and individual contents agents provide their own third apparatus 330, individual contents agents can provide the use limit using their own individual means and individual algorithm.

As shown in FIGS. 11 and 13, the third apparatus 330 is provided with reading means 337 reading information for removal of the use limit in a storage medium and inputting the information into the removal means 339 or operating means (not shown) for inputting information for removal of the use limit into removal means 339.

### BRIEF DESCRIPTION OF THE DRAWINGS

FIG. 1 is a schematic function block diagram of a use limit system to which the present invention is applied.

FIG. 2 is a flow chart showing the operation of the use limit system in Embodiment 1.

FIG. 3 is a flow chart showing the operation of the use limit system in Embodiment 1.

FIG. 4 is a conceptual diagram of data registered with storage means.

FIG. 5 is a conceptual diagram of data registered with storage means.

FIG. 6 is a conceptual diagram of data registered with storage means.

FIG. 7 is a schematic function block diagram of a use limit system to which the present invention is applied.

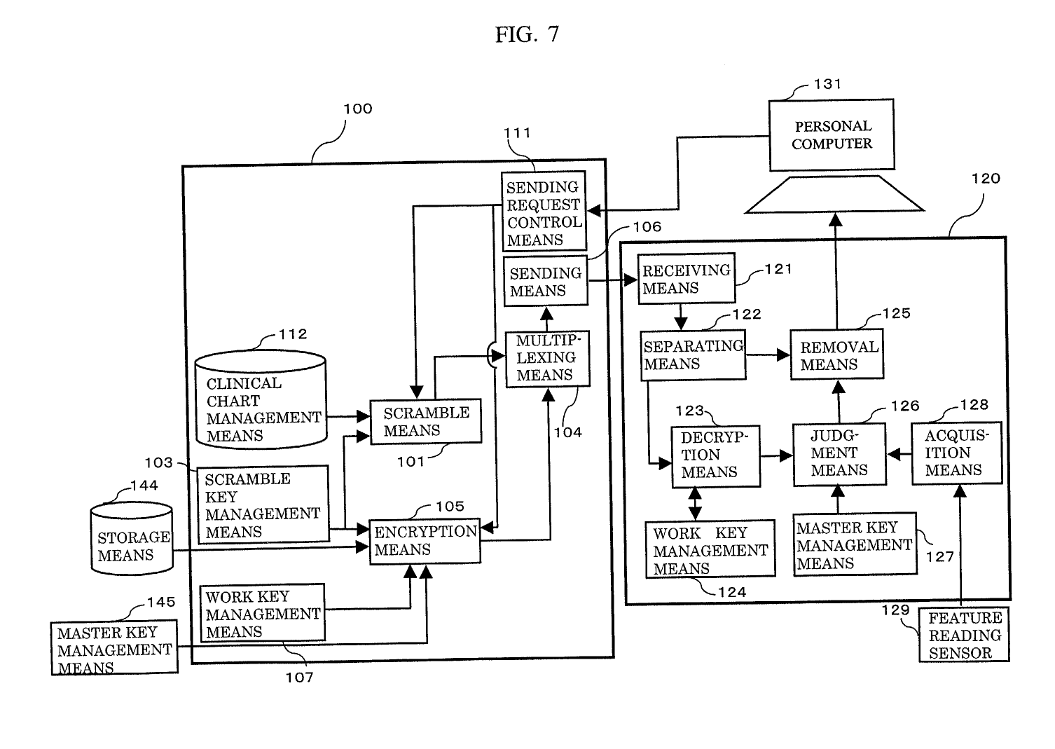

FIG. 8 is a schematic function block diagram of a use limit system to which the present invention is applied.

FIG. 9 is a schematic function block diagram of a first apparatus to which the present invention is applied.

FIG. 10 is a schematic function block diagram of a second apparatus to which the present invention is applied.

FIG. 11 is a schematic function block diagram of a third apparatus in Embodiment 5.

FIG. 12 is a schematic function block diagram of a third apparatus in Embodiment 6.

FIG. 13 is a schematic function block diagram of a third apparatus in Embodiment 7.

FIG. 14 is a schematic function block diagram of a use limit system to which the present invention is applied.

FIG. 15 is a flow chart showing the operation of the use limit system in Embodiment 5.

FIG. 16 is a flow chart showing the operation of the use limit system in Embodiment 7

### DESCRIPTION OF THE PREFERRED EMBODIMENTS

### EMBODIMENT 1

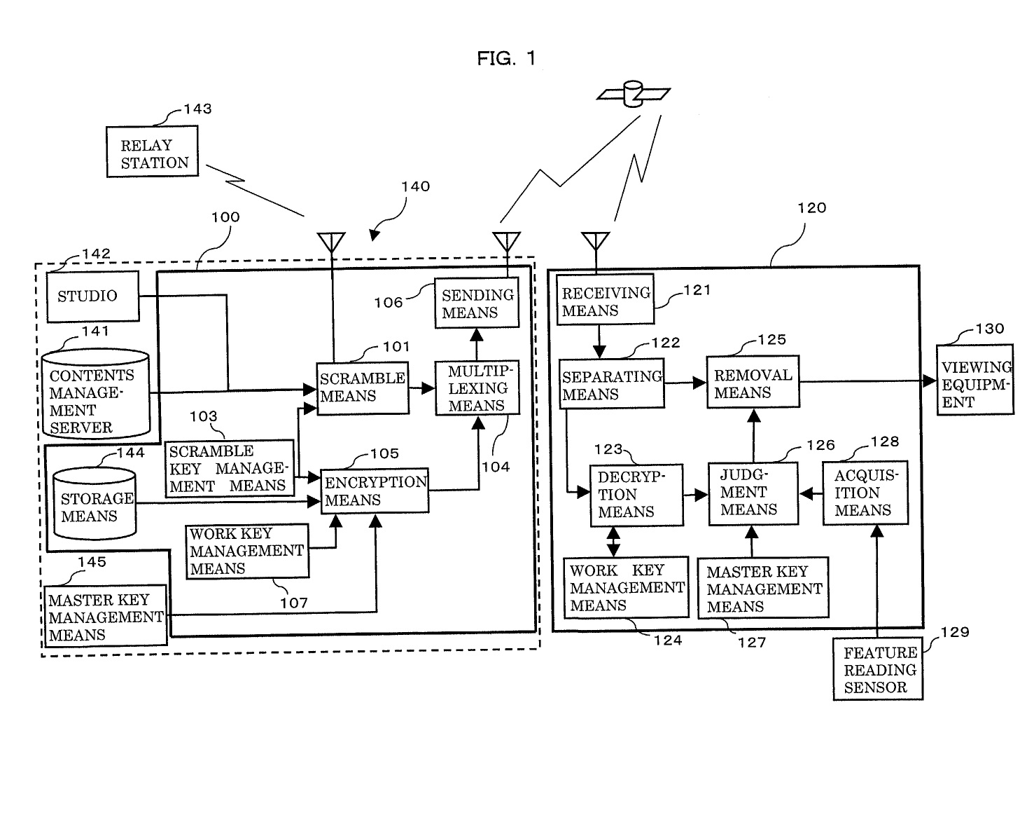

FIG. 1 shows a case in which sending apparatus 100 is used for TV broadcasting station 140 to send pay TV broadcast (hereinafter “pay broadcast”) as contents and set top box 120 is used as receiving apparatus for viewers to receive the pay broadcast.

TV broadcasting station 140 scrambles and broadcasts a pay broadcast program so that the pay broadcast may be viewable only when the pay broadcast is received by set top box 120 of a viewer who has made a viewing contract.

To view the pay broadcast of TV broadcasting station 140, the viewer has to hold a viewing contract with TV broadcasting station 140. That is, when making a viewing contract with TV broadcasting station 140, the viewer reports to TV broadcasting station 140 the product's number of the viewer's set top box 120, lot number, serial number etc. the identification number to identify the set top box 120, and the physical features of the viewer. The physical features are fingerprint, palm print, hand print, voiceprint, pattern of the retina, pattern of the iris, form of the face, and DNA. In the following description, it is to be understood that the physical features mean the fingerprint of the thumb.

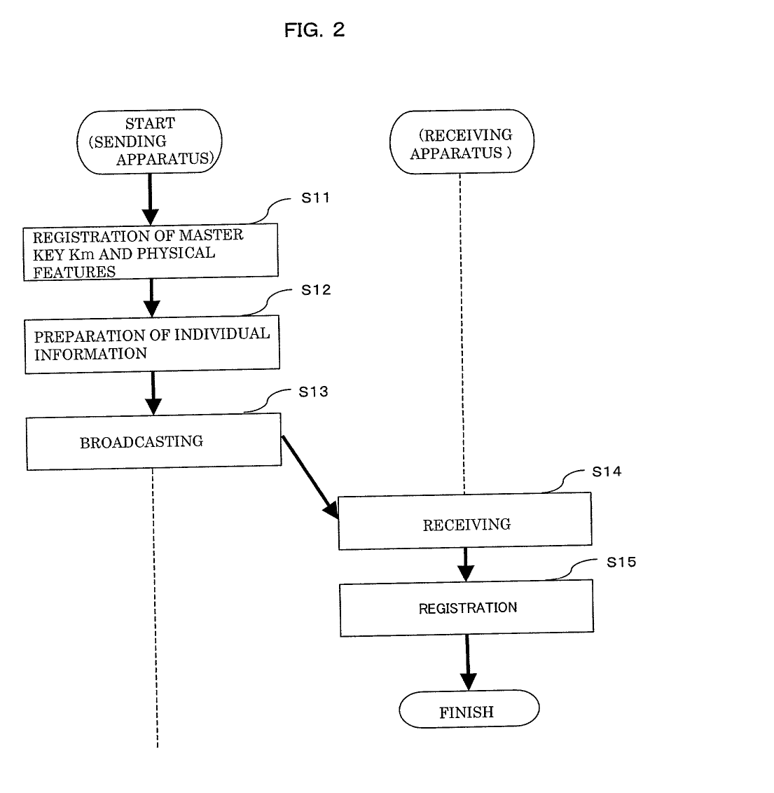

If TV broadcasting station 140 makes a viewing contract with a viewer, master key Km corresponding to the identification number of set top box 120 of the viewer is registered with master key management means 145 installed within TV broadcasting station 140, and the fingerprint of the viewer is registered with a storage means 144 (FIG. 2, Step S 11).

Furthermore, with a master key management means 127 provided in individual set top box 120, the master key Km corresponding to the identification number of set top box 120 is registered in the manufacturing stage of set top box 120.

When a viewing contract is made as mentioned above and a new master key Km is registered with master key management means 145, a encryption means 105 provided in the sending apparatus 100 encrypts work key Kw with the newly registered master key Km and makes individual information (FIG. 2 Step S 12). This work key Kw is a key to encrypt scramble key Ks that TV broadcasting station 140 uses to scramble a program of the pay broadcast, managed by work key management means 107 provided in the sending apparatus 100.

Individual information thus prepared is transferred to a multiplexing means 104, multiplexed with a program etc. by the multiplexing means 104 which will be described later, and broadcast via sending means 106 (FIG. 2, Step S 13).

So that the individual information may be received by the set top box 120 of a viewer making viewing contract, the TV broadcasting station 140 informs the viewer the broadcasting time when the individual information will broadcast beforehand. According to this notice, the viewer sets the channel of the receiving broadcast to the pay broadcast in set top box 120 so that set top box 120 receives the individual information at the broadcast time

The individual information sent from sending means 106 is received by a receiving means 121 of the set top box 120 (FIG. 2, Step S 14). The individual information received by the receiving means 121 is inputted into a separating means 122 and is separated from other information multiplexed with the individual information by the separating means 122. The separated individual information is inputted into a decryption means 123.

If the individual information is inputted, the decryption means 123 decrypts work key Kw included in the individual information with master key Km stored in the master key management means 127 (FIG. 2, Step S 15). If work key Kw is decrypted, the decryption means 123 registers the work key Kw with work key management means 124.

Master key Km used to encrypt work key Kw is master key Km stored in the viewer's set top box 120 of which the identification number is reported when the viewing contract is made. Therefore, even if the set top box of a viewer who has not made a viewing contract receives the above individual information, decryption means 123 provided in the set top box can not decrypt work key Kw.

Acquiring work key Kw, set top box 120 can decrypt a scramble key Ks that is decrypted and broadcast, and to descramble a program of the pay broadcast that is furthermore scrambled using the scramble key Ks and broadcast.

The scramble key Ks, which is managed by scramble key management means 103 in sending apparatus 100, is used in scrambling a program at TV broadcasting station 140 as shown below, and at the same time encrypted by work key Kw and broadcast.

When TV broadcasting station 140 broadcasts a filmed program, the program stored in contents management server 141 provided in TV broadcasting station 140 is sent to a scramble means 101 provided in the sending apparatus 100. In case a live relay broadcast is broadcast, TV broadcasting station 140 sends to the scramble means 101 a program prepared at studio 142 or relay station 143.

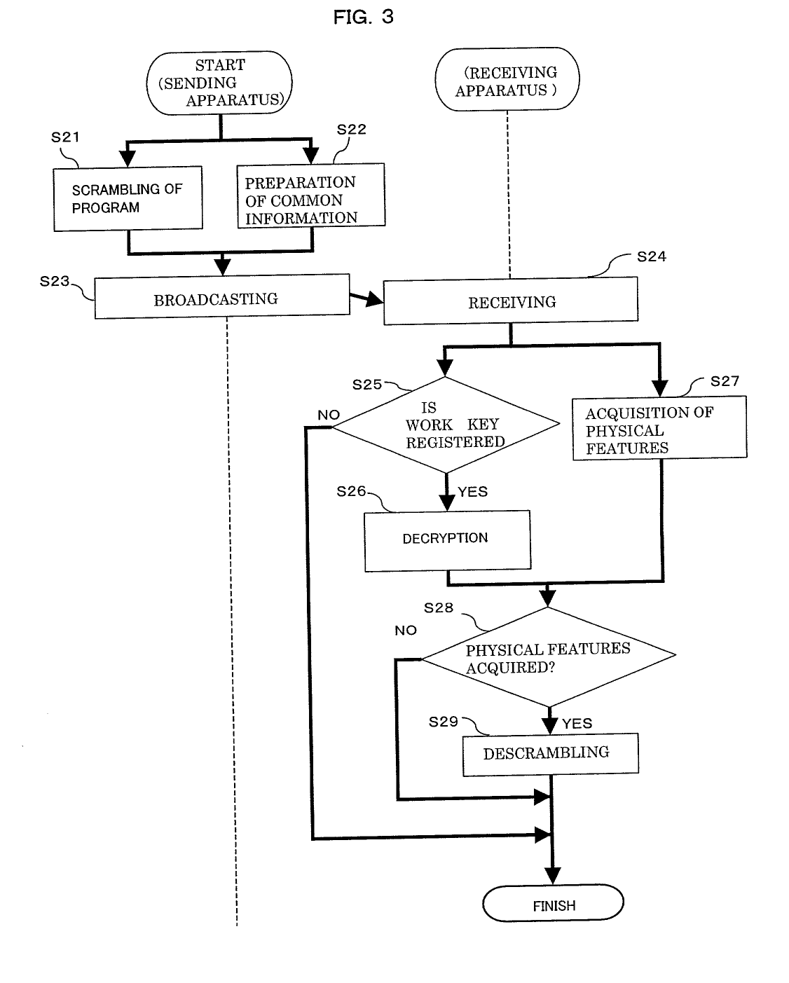

If a program is inputted from contents the management server 141, the studio 142 or the relay station 143, the scramble means 101 acquires scramble key Ks from the scramble key management means 103 and scrambles the sent out program using the scramble key Ks and transfers the program to the multiplexing means 104 (FIG. 3, Step S 21).

Meanwhile, in order that set top boxes 120 of all the viewers who have made viewing contracts can descramble the scrambled program, TV broadcasting station 140 multiplexes the scramble key Ks into the program and broadcasts. But if scramble key Ks is received by set top box 120 of a viewer who has made a viewing contract, a viewer who has not made a viewing contract can receive a pay broadcast through the set top box 120, decrypts scramble key Ks and descramble the program. To prevent viewers without making a viewing contract from descrambling a program, TV broadcasting station 140 makes a broadcast by multiplexing use permit information made up of the physical features of all the viewing contractors registered with storage means 144 and the scramble key Ks.

There is a possibility that if broadcast, the scramble key Ks and the use permit information are acquired by a third party. To block that, TV broadcasting station 140 makes a broadcast by encrypting the scramble key Ks and use permit information by the encryption means 105 (FIG. 3, Step S 22). Information in which the scramble key Ks and use permit information are encrypted shall be hereinafter called common information.

To prepare this common information, the encryption means 105 first acquires scramble key Ks from the scramble key management means 103 and use permit information from the storage means 144. Then, the encryption means 105 encrypts the acquired scramble key Ks and use permit information with work key Kw managed by the work key management means 107. And when common information is prepared, the encryption means 105 transfers the common information to the multiplexing means 104.

If one scramble key Ks is fixed, there is a possibility that a third party knows the scramble method, and to prevent that, the scramble key management means 103 changes scramble key Ks every several seconds.

If informed by the scramble key management means 103, for example, that scramble key Ks is changed, the encryption means 105 will re-prepare common information. That is, each time scramble key Ks is changed, the encryption means 105 acquires scramble key Ks from the scramble key management means 103 and use permit information from the storage means 144, and encrypts the acquired scramble key Ks and use permit information with work key Kw. And each time common information is re-prepared, the encryption means 105 transfers the prepared common information to the multiplexing means 104.

As a scrambled program is transferred from the scramble means 101, the multiplexing means 104 broadcasts the program as pay broadcast in principle through the sending means 106. But the common information and the individual information can be transferred from the encryption means 105 to the multiplexing means 104. When the common information and the individual information are transferred, the multiplexing means 104 broadcasts multiplex information with the common information and individual information multiplexed into a program as pay broadcast through the sending means 106 (FIG. 3, Step S 23).

As set forth above, since a program is scrambled by scramble means 101 and scramble key Ks is encrypted by the encryption means 105, a third party can not view a program even if the third party acquires broadcast wave of the pay broadcast.

When a viewer who has made a viewing contract views such a pay broadcast, the viewer applies power to set top box 120 and inputs an instruction into set top box 120 to select the channel for the pay broadcast using a remote control or the like.

When the instruction is given, pay broadcast from the sending apparatus 100 is inputted into separating means 122 via the receiving means 121 of set top box 120 (FIG. 3, Step S 24). In case information other than the program, that is, common information and individual information, are included in the pay broadcast, the separating means 122 separates common information and individual information from the program. And the program is transferred to the removal means 125, and common information and individual information are transferred to the decryption means 123. In case no information other than a program is included in the pay broadcast, the separating means 122 does not separate and transfers the program to the removal means 125.

If individual information is inputted from the separating means 122, the decryption means 123 decrypts work key Kw of individual information with master key Km as described above. If common information is inputted, the decryption means 123 judges if the work key Kw is registered with the work key management means 124 (FIG. 3, Step S 25). In case it is judged that work key Kw is registered, the decryption means 123 takes out work key Kw from the work key management means 124, and decrypts scramble key Ks and use permit information included in common information and sends them to a judgment means 126 (FIG. 3, Step S 26).

Meanwhile, after the user applies power to set top box 120 and adjusts the reception channel to the pay broadcast as described above, the viewer puts the thumb on feature reader (sensor) 129 making up the acquisition means 128 provided in set top box 120 (FIG. 3, Step S 27). If the feature reader 129 is put thumb ,the feature reader 129 is read the thumb fingerprint. The read fingerprint as fingerprint information is acquired by the acquisition means 128 and inputted into the judgment means 126. It is noted that an arrangement may be so made that feature reader 129 is detachably fixed on the acquisition means 128.

If use permit information is inputted from the decryption means 123 and fingerprint information is inputted from the acquisition means 128, the judgement means 126 judges whether a fingerprint information is included in the use permit information found to be identical with the fingerprint information inputted from acquisition means 128 (FIG. 3, Step S 28). If it is judged that the fingerprint information found, judgement means 126 gives scramble key Ks to the removal means 125. If it is judged in the judgement step S28 that a fingerprint information information is included in the use permit information found to be identical with the fingerprint information, the judgement means 126 gives the removal means 125 scramble key Ks transferred from the decryption means 123 even if no fingerprint information is inputted from the acquisition means 128 for a certain period after judgement. The certain period after judgement is a period from judgement to cutoff of power of set top box 120, a period until a program ends, 1 hour, 2 hours . . . after judgement, for example.

Receiving scramble key Ks, the removal means 125 descrambles a program transferred from the separating means 122 using the scramble key Ks (FIG. 3, Step S 29). The removal means 125 sends the descrambled program to viewing equipment 130 such as a monitor, speaker etc. connected to set top box 120. Thus, the scrambled program is sent to viewing equipment 130, and viewing equipment 130 can reproduce the program.

If it is judged in the judgement step S 25 that work key Kw is not registered, the decryption means 123 does not decrypt scramble key Ks and use permit information included in common information but transfers the common information to the judgement means 126. Therefore, the judgement means 126 can not judge whether fingerprint information inputted from the acquisition means 128 is included in use permit information. In case judgement can not be made, the judgement means 126 does not give scramble key Ks to the removal means 125. Thus, to viewing equipment 130, a scrambled program is sent, and viewing equipment 130 can not reproduce the program.

Furthermore, if the judgment means 126 judges in the judgment step S 28 that fingerprint information is included in the use permit information does'nt found to be identical with the fingerprint information the judgment means 126 does not give scramble key Ks to the removal means 125.

Thus, if a use limit which is removed when the broadcast physical feature and that acquired by the acquisition means 128 are identical is set on contents, set top box 120 can not descramble the program even if a viewer who has not made a viewing contract with TV broadcasting station 140 has the fingerprint reader 129 read a fingerprint.

In the above description of the receiving apparatus 120, set top box 120 is held up an example. But if the receiving apparatus 120 is provided with a monitor, speaker and others in addition to the functions that set top box 120 has, the removal means 125 may send a descrambled program to a monitor or speaker provided in the receiving apparatus 120.

Furthermore, there is a possibility that a program descrambled by the removal means 125 may be acquired and viewed by a third party while being sent from the removal means 125 to the viewing equipment 130. To prevent that, the removal means 125 may send the descrambled program to the viewing equipment 130 after encrypting the program as mentioned above. In case a program is encrypted and sent like that, viewing equipment 130 has to have a decryption key to reproduce an encrypted program.

In case a plurality of persons view a pay broadcast using one set top box 120, it is necessary to report the identification number of set top box 120 and the physical features of all the persons to TV broadcasting station 140. An example in which a plurality of persons use one set top box 120 is this: all members of a family use one set top box 120 at their home.

If the physical features of all members of a family, for example, are reported to TV broadcasting station 140, the physical features of all the family members will be registered with the storage means 144 by TV broadcasting station 140. If the physical features of all the family members are registered with storage means 144, the common information includes the physical features of all the family members and any member of the family can have the fingerprint reader 129 read the fingerprint and view a pay broadcast.

### EMBODIMENT 2

The viewing contract in Embodiment 1 is a contract permitting viewing all the programs broadcast by TV broadcasting station 140. The viewing contract may be a contract permitting specific programs only, for example.

When a viewing contract for news programs, for example, is made, the viewer reports to TV broadcasting station 140 the identification number of set top box 120, physical features and news program.

If a viewing contract for a new program is made, TV broadcasting station 140 will register with the master key management means 145 the master key Km corresponding to the identification number of set top box 120 of the viewer who has made a viewing contract, and registers with the storage means 144 the physical features by relating them to the program identification number of the new program involved in the viewing contract.

If the master key Km is registered with the master key management means 145, the work key Kw will be sent to set top box 120 of the viewing contract viewer in the same way as in Embodiment 1.

Then, when a news program involved in the viewing contract is broadcast, TV broadcasting station 140 sends to the scramble means 101 the news program prepared at the studio 142 or the like as described above. The scramble means 101 scrambles the sent out news program with the scramble key Ks and transfers the program to the multiplexing means 104.

To send the scramble key Ks and use permit information to set top box 120, TV broadcasting station 140 inputs the program identification number of the news program to the encryption means 105 when broadcasting the news program.

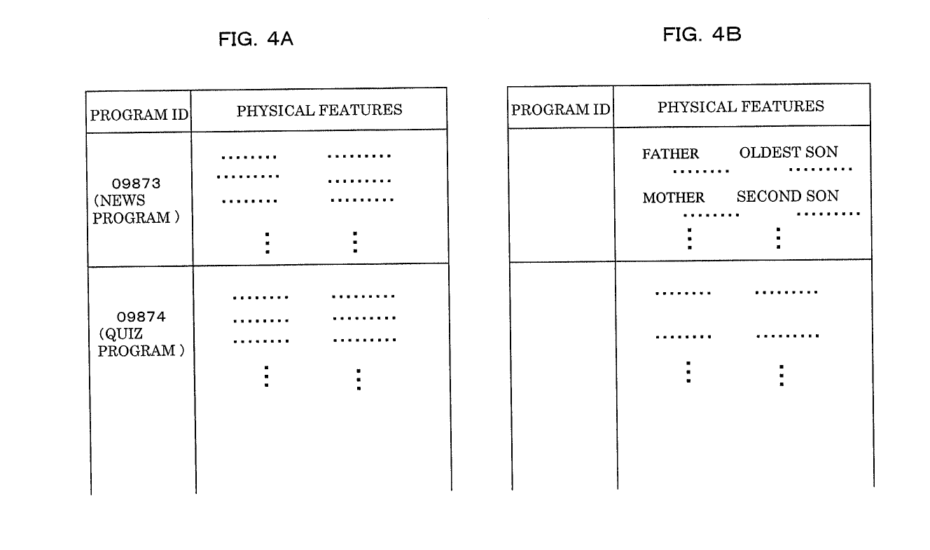

If a program identification number is inputted, the encryption means 105 acquires from the storage means 144 a physical feature (use permit information) registered by relating the physical feature to the program identification number of a news program as shown in FIG. 4A and gets scramble key Ks from the scramble key management means 103. The encryption means 105 prepares common information by encrypting the acquired the scramble key Ks and, the use permit information with work key Kw and sends the prepared the common information to the multiplexing means 104. Needless to say, in present embodiment, too, the scramble key Ks is changed at certain intervals, and each time the scramble key Ks is changed, the encryption means 105 re-prepares the common information.

The multiplexing means 104 multiplexes the transferred the common information into a program transferred from the scramble means 101 and broadcasts the common information through sending means 106.

If the physical feature is registered by relating the physical feature to the program identification number, it is possible to broadcast use permit information corresponding to a program now being broadcast. In Embodiment 2, the news program and the physical features of a person only who has made a viewing contract are broadcasting, and therefore those who have not made a viewing contract for the news program can not view the news program.

In case all the members of a family view a news program using one set top box 120, it is necessary to report to TV broadcasting station 140 the identification number of set top box 120, news program for viewing contract, and the physical features of all the family members when a viewing contract is made.

If the physical features of all the family members are reported when a viewing contract is made, TV broadcasting station 140 registers the physical features of all the family members by relating the physical features to the program identification number of the news program as shown in FIG. 4B. Then, use permit information of the news program includes the physical features of all the family members involved in the viewing contract. Thus, any member of the family involved in the viewing contract can view the news program by having the fingerprint reader read the fingerprint of the thumb.

### EMBODIMENT 3

In Embodiment 1, it is explained that if the broadcast physical feature is identical with the fingerprint acquired by the acquisition means 128 of set top box 120, the removal means 125 descrambles the program. Thus, a viewer who has the physical feature registered with the storage means 144 can descramble the program using not only the viewer's own set top box 120 but also another's set top box 120 storing the work key Kw in the work key management means 124.

In case many viewers who have made a viewing contract does not want to have the viewer's own set top box 120 used by the another set top box 120 owner, TV broadcasting station 140 has each viewer report the physical feature and the identification number of one set top box 120 or the identification numbers of a plurality of set top boxes 120.

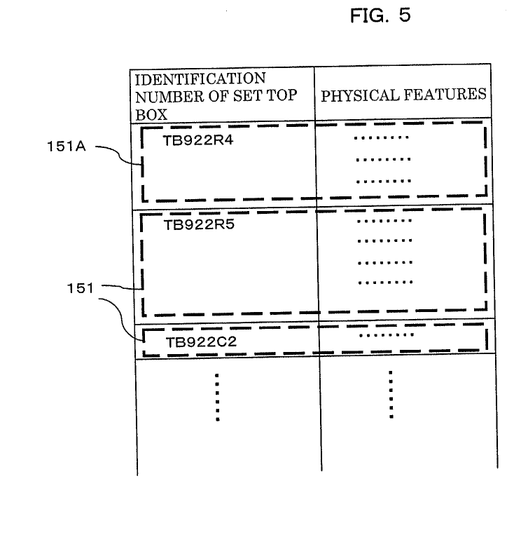

If a viewing contract is made, TV broadcasting station 140 registers with the master key management means 145 the master key Km corresponding to the identification number of one set top box 120 or the identification numbers of a plurality of set top boxes 120 reported for the viewing contract. In addition, TV broadcasting station 140 registers with the storage means 144 limit removal information 151 in which the physical features of a viewer making a viewing contract are related to master key Km corresponding to the identification number (s) of one or a plurality of set top boxes 120 reported for the viewing contract as shown in FIG. 5.

After the master key Km is registered with the master key management means 145, the work key Kw is sent to set top box 120 of the viewer who has made a viewing contract in the same way as in Embodiment 1.

Also, as Embodiment 1, each time the scramble key Ks is changed, common information is prepared at the encryption means 105, and the common information is multiplexed with a program etc. and broadcast. However, details of common information in the present embodiment are different from those in Embodiment 1. That is, the details of common information in the present embodiment, that is, Embodiment 3 are all limit removal information 151 registered with the storage means 144 and the scramble key Ks which are encrypted with work key Kw.

As explained, if common information including limit removal information 151 is received by the receiving means 121, the separating means 122 separates the common information from programs and the like, and inputs the common information into the decryption means 123.

If the common information is inputted, the decryption means 123 decrypts the limit removal information 151 and scramble key Ks included in the common information using the master key Km as described above. The decryption means 123 transfers decrypted the limit removal information 151 and the scramble key Ks to the judgement means 126.

If the limit removal information 151 and the scramble key Ks are transferred and fingerprint information of the thumb is inputted from the acquisition means 128, the judgement means 126 extracts from the limit removal information 151 limit removal information 151A including the same master key Km as the master key Km stored in the master key management means 127.

Next, judgment means 126 judges whether the fingerprint information found to be identical with the fingerprint information inputted from the acquisition means 128 is included in limit removal information 151A. If it is judged as included, the judgment means 126 transfers the scramble key Ks to the removal means 125.

As described, if limit removal information 151 including the master key Km and the physical features are included in the common information, TV broadcasting station 140 can limit set top box to one or a plurality of specific set top boxes 120 using descramble the program.

In case all the family members view a pay program using set top box 120 at their house only, it is arranged that the physical features of all the family members and the identification number of set top box 120 of their house are reported to TV broadcasting station 140.

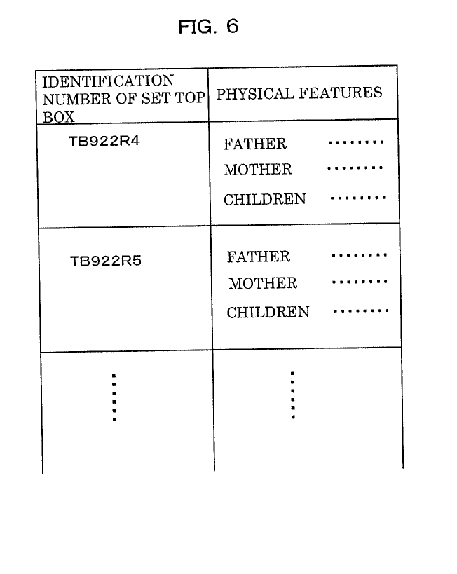

If a report is made, TV broadcasting station 140 registers the report with the storage means 144 by relating the identification number of set top box 120 to the physical features of all the family members as shown in FIG. 6.

If a report is registered by relating the identification number of set top box 120 at the house of this family to the physical features of all the family members like that, it is possible for all the family members to descramble the program using set top box 120 at their home.

### EMBODIMENT 4

The setting of apparatus 100 and the receiving apparatuses 120 that can be for limit of pay broadcast and removal of the use limit has been described. The setting of apparatus 100 and the receiving apparatuses 120 can be used for other than the setting or removal of the use limit of pay broadcasting.

For example, reference to the patient's chart is limited to a specific person. The patient's chart is memorized in the sending apparatus 100, and the patient's chart at information terminal of a personal computer or the like is connected with the sending apparatus 100 via LAN, Internet or the like.

In this case, it is a prerequisite that the fingerprint of a person who has been permitted to refer to the patient's chart is registered in advance with the storage means 144 and the work key Kw is registered with the work key management means 124 of the receiving apparatus 120 communicably connected with the information terminal. Fingerprint information and the work key Kw can be registered in the same way as Embodiment 1.

For example, a doctor who is permitted to refer to patient charts sends a request for a specific patient's chart to the sending apparatus 100 using personal computer 131 connected with the sending apparatus 100 and LAN. This sending request includes the identification number of the receiving apparatus 120 communicably connected with personal computer 131 and identification number of the patient for the patient's identification.

The sending request sent from personal computer 131 is received by sending request control means 111 in the sending apparatus 100. Receiving the sending request, the sending request control means 111 transferrs the patient's identification number to the scramble means 101 and the encryption means 105 and the identification number of receiving apparatus 120 to the sending means 106.

Receiving the patient's identification number, the scramble means 101 acquires the patient's chart corresponding to the patient's identification number received from clinical chart management means 112 storing patient's charts, and scrambles the chart with scramble key Ks. The scrambled chart is transferred to the multiplexing means 104.

Receiving a patient's identification number, the encryption means 105 prepares common information by encrypting scramble key Ks and the physical feature registered with the storage means 144 with physical features and transfers the common information to multiplexing means 104.

The multiplexing means 104 multiplexes the transferred scrambled chart and common information and sends to the sending means 106.

Receiving information with the chart and common information multiplexed from the multiplexing means 104, the sending means 106 sends the information to receiving apparatus 120 of the identification number sent in from the sending request control means 111.

The scrambled patient's chart and common information sent in from the sending means 106 are received by receiving means 121 in receiving apparatus 120. The patient's chart and common information received by receiving means 121 are separated by the separating means 122, and the scrambled patient chart is transferred to the removal means 125 and the common information is transferred to the decryption means 123.

The subsequent processing is the same as that in Embodiment 1 except that the program is the patient's chart. That is, the doctor who wants to see the patient's chart has the fingerprint of the thumb read by the fingerprint reader, and only when it is judged for by the judgment means 126 that a fingerprint found to be identical with the doctor's fingerprint in the common information will be descrambled by the removal means 125. The descrambled patient's chart will be displayed on the monitor of personal computer 131 connected with receiving apparatus 120.

In the present embodiment, the contents are a patient's chart and, the person who is permitted to see the patient's chart may be a doctor. The contents may be files on accidents and events possessed by police, and the person who is permitted to see the files may be a policeman.

### EMBODIMENT 5

The method of setting such use limit is possible to change by revising encryption standards, merging TV broadcasting stations 140 or the like. Each time the method of setting the use limit is changed, the contents user has to buy the receiving apparatus 120 that can remove the changed use limit. The receiving apparatus 120 provided with functions of receiving contents and removing the use limit is expensive and is a heavy economic burden for contents user. Furthermore, to use a plurality of contents on which the use limit is set in different methods, the contents user will have to buy receiving apparatus 120 having functions of removing the use limit on each contents.

Therefore, the present embodiment will describe the reading of physical features using third apparatus 330 that has a function of reading removal information to remove the use limit.

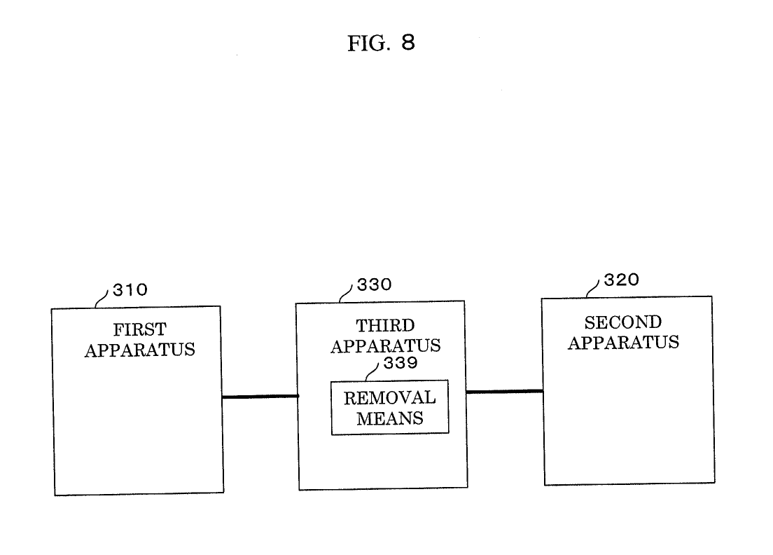

As shown in FIG. 8, the prerequisite is a use limit system, that is, when the use limit of contents received by first apparatus 310 is removed on the basis of removal information on the use limit, the contents can be viewed on second apparatus 320.

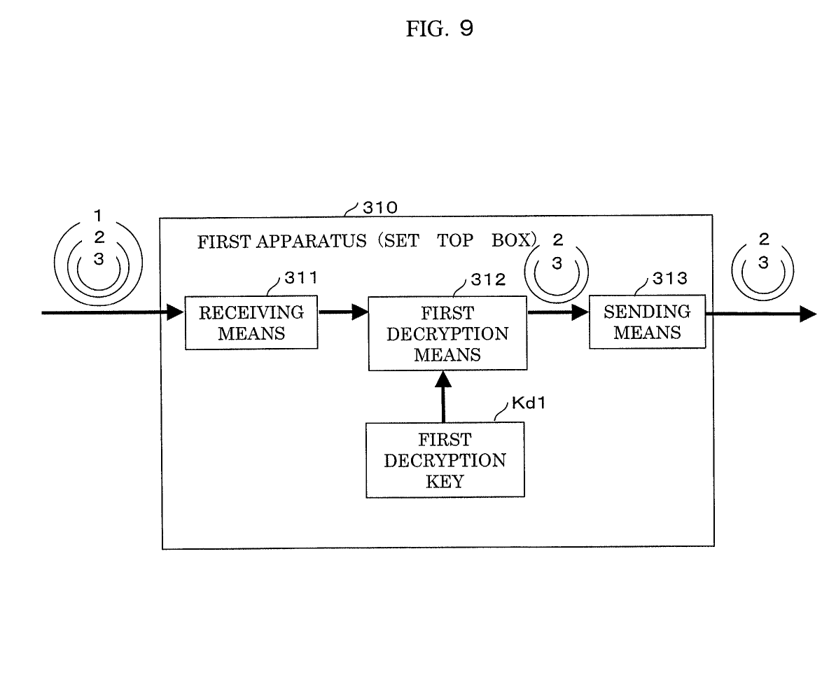

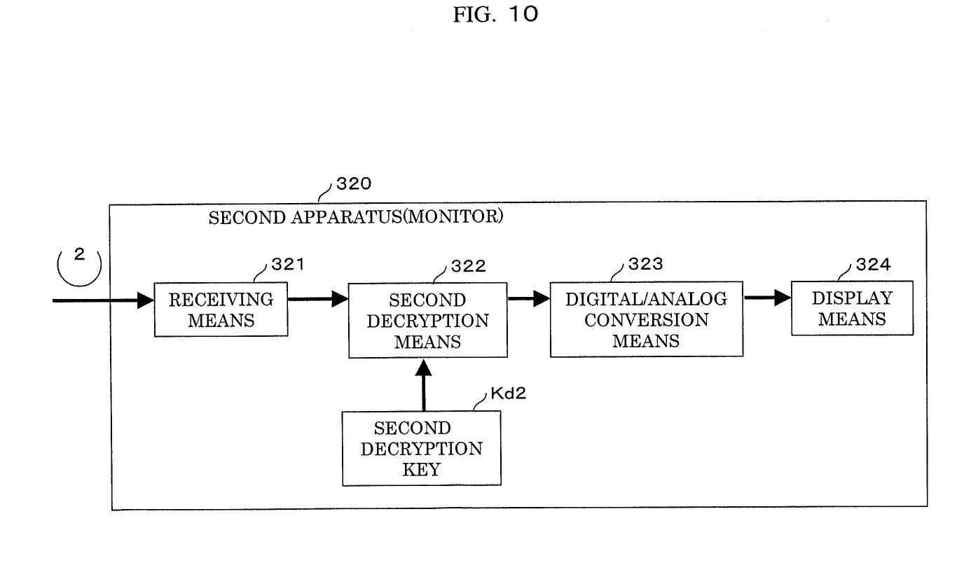

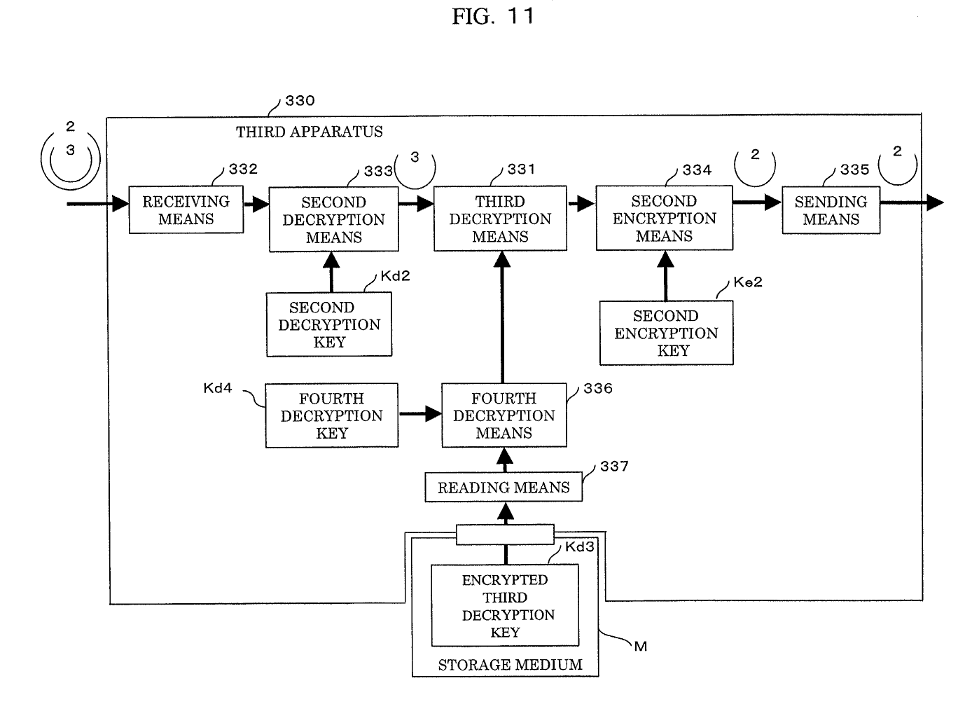

The term first apparatus 310 used herein is an apparatus such as set top box, CD player or the like to get contents as shown in FIG. 9. The second apparatus 320 is an apparatus such as monitor, personal computer or the like to utilize contents as shown in FIG. 10. That is, the second apparatus 320 corresponds to viewing equipment 130 in Embodiment 1. And the third apparatus 330 is an apparatus offered in the form adapter to connect the first apparatus 310 and the second apparatus 320 as shown in FIG. 11.

Now, there will be described a use limit system as example in which a set top box is adopted as the first apparatus 310 shown in FIG. 9 and a monitor is used as the second apparatus 320 shown in FIG. 10. It is to be understood that in the following description contents and related information will be collectively called “data.”

In the present embodiment, it is assumed that data received by first apparatus 310 is trebly encrypted on broadcasting station side. This treble encryption consists of the following three: first encryption for protection in transmission between the broadcasting station and the first apparatus 310; second encryption for transmission protection between the first apparatus 310 and the second apparatus 320; and third encryption to prevent data from being used by a person who has not made a viewing contract with the contents agent.

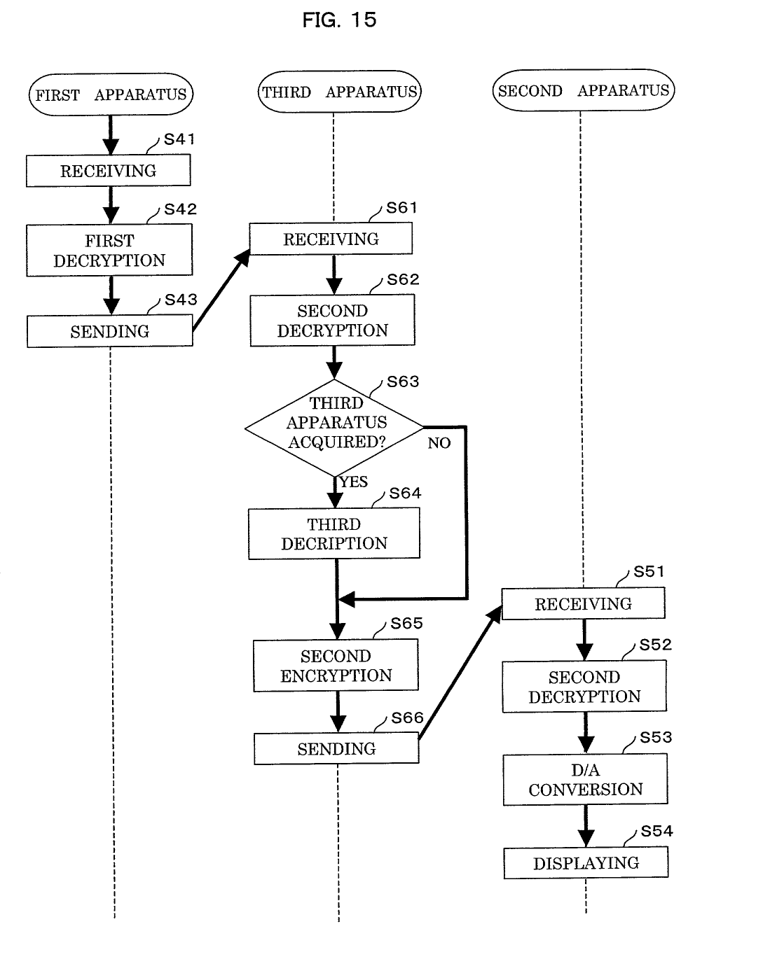

First, data received by receiving means 311 in the first apparatus 310 is usually encrypted (scrambled) by the first encryption method (FIG. 15, Step S 41).

Therefore, first decryption means 312 which receives the encrypted data from the receiving means 311 decrypts (descrambles) this data using first decryption key Kd1, and then refers this decrypted data to sending means 313 (FIG. 15, Steps S 42→S 43).

The reason why data received by the receiving means 311 in the first apparatus 310 is encrypted is to protect protection between the broadcasting station and the first apparatus 310 (to provide the sending system with a special use limit). That is, the reason why data received by receiving means 311 in first apparatus 310 is encrypted is the same reason that the scramble key Ks and removal conditions in Embodiment 1 are encrypted with the work key Kw. Therefore, in case data received by the receiving means 311 in first apparatus 310 is not encrypted, it is not necessary to provide the first apparatus 310 with the first decryption means 312 and the first decryption key Kd1.

Next, since data passed on to the sending means 313 in the first apparatus 310 is encrypted by second encryption method, the data is inputted into second decryption means 333 in the third apparatus 330 through a receiving means 311 in the third apparatus 330 (FIG. 15, Step S 61). Hereby, second decryption means 333 decrypts the data using second decryption key Kd2 (FIG. 15, Step S 62), and then refers this decrypted data to third decryption means 331.

Thus, the reason why data received by receiving means 332 in the third apparatus 330 is further encrypted is to provide protection between the first apparatus 310 and the third apparatus 330 and between the third apparatus 330 and the second apparatus 320 (to provide the reproduction system with a special use limit). Therefore, in case those sections are not protected, that is, data received by the receiving means 332 in the third apparatus 330 is not encrypted, it is not necessary to provide the third apparatus 330 with the second decryption means 333 and the second decryption key Kd2, and, furthermore, second encryption means 334 which will be described later and second encryption key Ke2.

Meanwhile, the third apparatus 330 is provided with a function capable of reading storage medium M such as IC card in which “third decryption key Kd3 encrypted by fourth encryption method” is stored by the broadcasting station. This storage medium M is given to a viewer by the broadcasting station when a viewing contract is made.

If the storage medium M is inserted on third apparatus 330, reading means 337, which detects that, reads “third decryption key Kd3 encrypted by fourth encryption method” stored in storage medium M and passes the third decryption key Kd3 on to a fourth decryption means 336.

Hereby, the fourth decryption means 336 decrypts “third decryption key Kd3 encrypted by fourth encryption method” using fourth decryption key Kd4, and then passes this third decryption key Kd3 on to the third decryption means 331.

The reason why third decryption key Kd3 stored in storage medium M is encrypted like that is to prevent this third decryption key Kd3 from being read in other than the third apparatus 330. Therefore, in case this prevention mechanism is not provided, that is, in case third decryption key Kd3 stored in storage medium M is not encrypted, it is not necessary to provide the third apparatus 330 with the fourth decryption means 336 and the fourth decryption key Kd4.

As a result, data decrypted by second decryption means 333 and third decryption key Kd3 decrypted by fourth decryption means 336 are inputted into the third decryption means 331. Then, the third decryption means 331 decrypts the data using third decryption key Kd3, and refers this encrypted data to the second encryption means 334.

The reason why the data decrypted by second decryption means 333 is further encrypted is to prevent the contents from being viewed by a person who has not made a viewing contract (to provide a use limit for contents). In other words, only a person who has made a viewing contract with the contents agent and has obtained storage medium M storing third decryption key Kd3 can remove the viewing limit to the contents by the third decryption means 331.

But third decryption key Kd3 read from the storage medium M as described above is a decryption key provided by the contents agent, but is not always a decryption key for the contents.

That is, if the third decryption key Kd3 read from storage medium M is a decryption key for the contents, the data decrypted by the third decryption means 331 (data with the viewing limit removed) is inputted into the second encryption means 334 (FIG. 15, Step S 63: YES→S 64). On the other hand, in case third decryption key Kd3 read from storage medium M is not a decryption key for the contents, the third decryption will fail. Therefore, data encrypted by the third encryption method (data with the viewing limit) is inputted into second encryption means 334 (FIG. 15, Step S 63: NO).

As the third decryption key, the physical features of a person who makes a viewing contract may be used. In this case, the contents agent also uses the physical features of the contract viewer to encrypt contents.

For example, the contents agent encrypts contents using the fingerprint of the viewing contract person. When the contract person views contents, the viewer inserts the storage medium M into the third apparatus and has the fingerprint read by a fingerprint reader provided in the storage medium M. The fingerprint read by storage medium M is inputted into third decryption means 331 via reading means 337 in third apparatus 330.

Thus, the third decryption means 331 is provided with functions possessed by the removal means 125 of set top box 120 in Embodiment 1, while fourth decryption means 336 is provided with functions possessed by the judgment means 126 of set top box 120.

It is noted that the fingerprint reader may be provided in third apparatus 330 and not in the storage medium M. If the fingerprint reader is provided in third apparatus 330, the viewer does not have to insert the storage medium into the third apparatus.

Furthermore, in case contents encrypted with the physical features are decrypted, it is not necessary to provide third apparatus 330 with the fourth decryption means 336 and fourth decryption key Kd4.

As described above, the encrypted contents and the user's fingerprint are inputted into the third decryption means 331. Only in case the inputted fingerprint is a fingerprint used for encryption of contents, the third decryption means 331 can decrypt contents.

Now, if data is inputted into second encryption means 334 from the third decryption means 331 as described above, second encryption means 334 encrypts the data using second encryption key Ke2, and then refers this encrypted data to sending means 335 (FIG. 15, Steps S 65→S 66).

And since the data referred to the sending means 335 in the third apparatus 330 as shown in FIG. 11 is encrypted by the second encryption method, the data is inputted into second decryption means 322 via receiving means 321 in the second apparatus 320 (FIG. 15, Step S 51). Hereby, the second decryption means 322 decrypts the data using second decryption key Kd2 (FIG. 15, Step S 52), and then passes this decrypted data on to digital/analog conversion means 323.

Finally, the digital/analog conversion means 323 converts into an analog signal the data received from second decryption means 322 and inputs the signal into display means 324, and then the contents is displayed on this display means 324 (FIG. 15, Steps S 53→S 54).

But in case third decryption key Kd3 read from storage medium M is not a decryption key for the contents, the data referred to the digital/analog conversion means 323 from second decryption means 322 as described above is data encrypted by the third encryption method (data with a viewing limit). Therefore, needless to say, normal display can not be obtained in the display means 324 in such a case.

As set forth above, the present invention is so arranged that the third decryption means 331 which functions as removal means 339 is provided in the third apparatus 330. Then, as long as each contents agent follows specific rules (for example, inputted data is decrypted by second decryption means 333, and data to be outputted is encrypted by second encryption means 334), the agent, in addition, can offer the third apparatus 330 provided with the use limit using its own means or its own algorithm. That is, each contents agent can decide to adopt what kind or intensity of encryption method as third encryption method or whether to encrypt third decryption key Kd3.

Furthermore, as set forth above, the following rules are promised in the third apparatus 330 to which the present invention is applied. That is, inputted data is decrypted by the second decryption means 333, and data to be outputted is encrypted by the second encryption means 333.

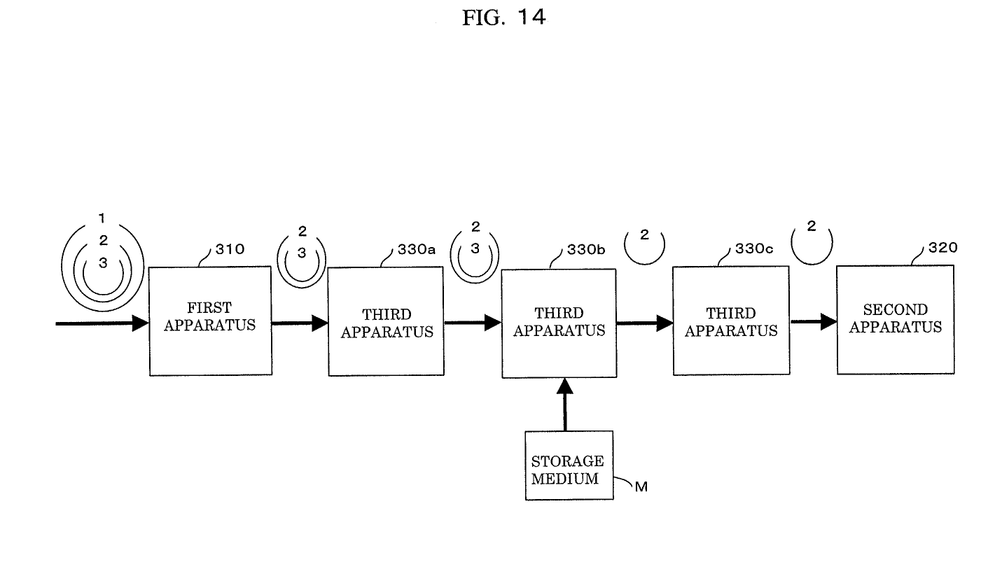

Therefore, it is possible to connect the first apparatus 310 and second apparatus 320 via a plurality of the third apparatuses 330 as via connecting third apparatus 330a offered by contents agent A, third apparatus 330b offered by contents agent B, third apparatus 330c offered by contents agent C as shown in FIG. 14. In this case, for example, to remove the use limit on contents offered by contents agent B, removal information (third decryption key Kd3) is inputted into removal means (third decryption means) 331 provided in the third apparatus 330b.

### EMBODIMENT 6

An arrangement may be so made that only in case trebly encrypted data by first to third encryption methods as in Embodiment 5 is broadcast together with the physical features of viewers and the physical features of viewers who have made a viewing contract is inputted into the third apparatus 330, the data can be used.

In this case, if a viewer makes a viewing contract, the broadcasting station broadcasts the work key Kw encrypted with the master key Km registered with the master key management means 127 in third apparatus 330.

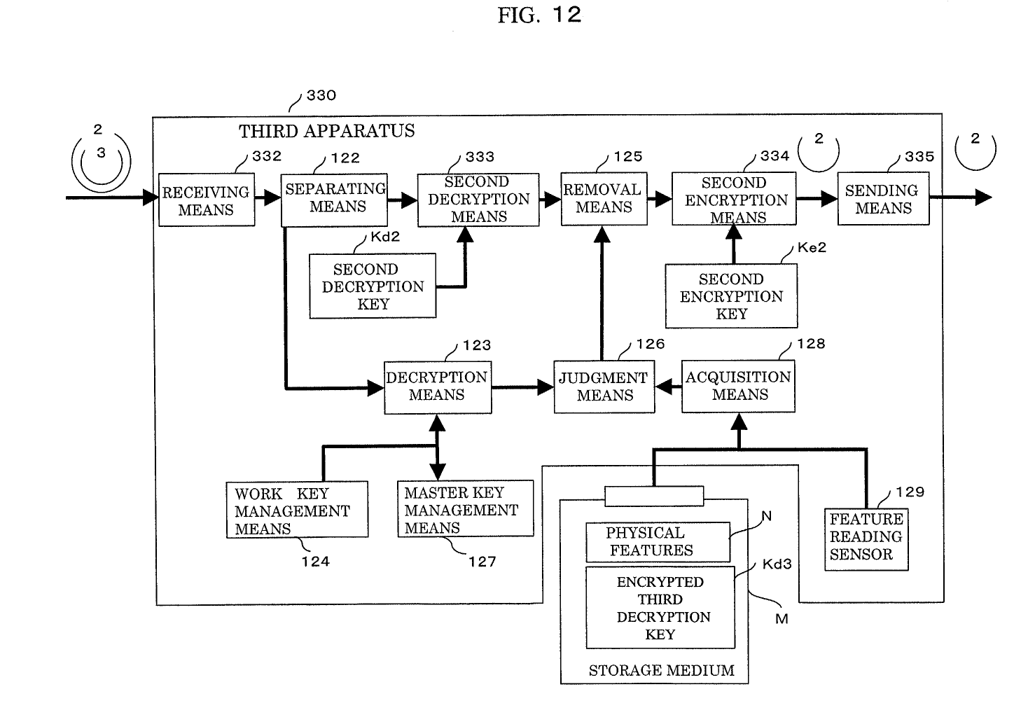

As shown in FIG. 12, the work key Kw encrypted with the master key Km is received by separating means 122 via first apparatus 310 of the viewer and receiving means 332. The separating means 122 inputs into decryption means 123 the work key Kw encrypted with the received master key Km.

If work key Kw encrypted with the master key Km is inputted, the decryption means 123 takes out the master key Km from the master key management means 127, decrypts work key Kw and registers the decrypted the work key Kw with the work key management means 124.

As Embodiment 1, the trebly encrypted data (encrypted by first to third encryption methods) is multiplexed with the physical features of all the viewers encrypted with the work key Kw and broadcast.

As in Embodiment 5, the trebly encrypted data is received by the separating means 122 via the first apparatus 310 and the receiving means 332 in third apparatus 330, while the physical features of all the viewers encrypted with the work key Kw is received by the separating means 122 in a state encrypted with the work key Kw.

The separating means 122 inputs the trebly encrypted data into the second decryption means 333 and inputs in decryption means 123 the physical features of all the viewers encrypted with work key Kw.

The second decryption means 333 decrypts the received data with second decryption key Kd2 as described above and passes the data on to the removal means 125 shown in FIG. 12.

Meanwhile, if the physical features of all the viewers encrypted with work key Kw is inputted, the decryption means 123 takes out work key Kw from the work key management means 124, decrypts the physical features and transfers the decrypted physical features to the judgment means 126 shown in FIG. 12.

When a viewer is going to use data, the user inserts into the third apparatus the storage medium M distributed by the broadcasting station as in Embodiment 5. In the present Embodiment 6, the storage medium M stores the physical feature N of viewers to whom the storage medium M is distributed as shown in FIG. 12 and third decryption key Kd3.

If storage medium M is inserted, the acquisition means 128 provided in the third apparatus 330 acquires the physical feature N stored in the storage medium M and third decryption key Kd3, and inputs into the judgment means 126 the acquired physical feature N and third decryption key Kd3.

If the physical features are inputted from the decryption means 123 and the acquisition means 128, the judgement means 126 judges whether it can be considered that the physical features inputted from the decryption means 123 and those from the acquisition means 128 are the same.

If they are judged as identical, the judgement means 126 gives the removal means 125 third decryption key Kd3 inputted from the acquisition means 128.

Receiving third decryption key Kd3, the removal means 125 decrypts data transferred from second decryption means 333 using the third decryption key Kd3. The removal means 125 gives the decrypted data to second encryption means 334 in third apparatus 330 as in Embodiment 5. The subsequent processing is identical with that in Embodiment 5.

As set forth above, only in case the physical feature N of a viewer who has made a viewing contract is inputted into the third apparatus 330, data will be decrypted.

In the above description, the storage medium M stores physical feature N. In case the third apparatus 330 is provided with feature the reading sensor 129 the storage medium M does not have to store physical feature N. In this case, the acquisition means 128 acquires physical feature N through the feature reading sensor 129.

### EMBODIMENT 7

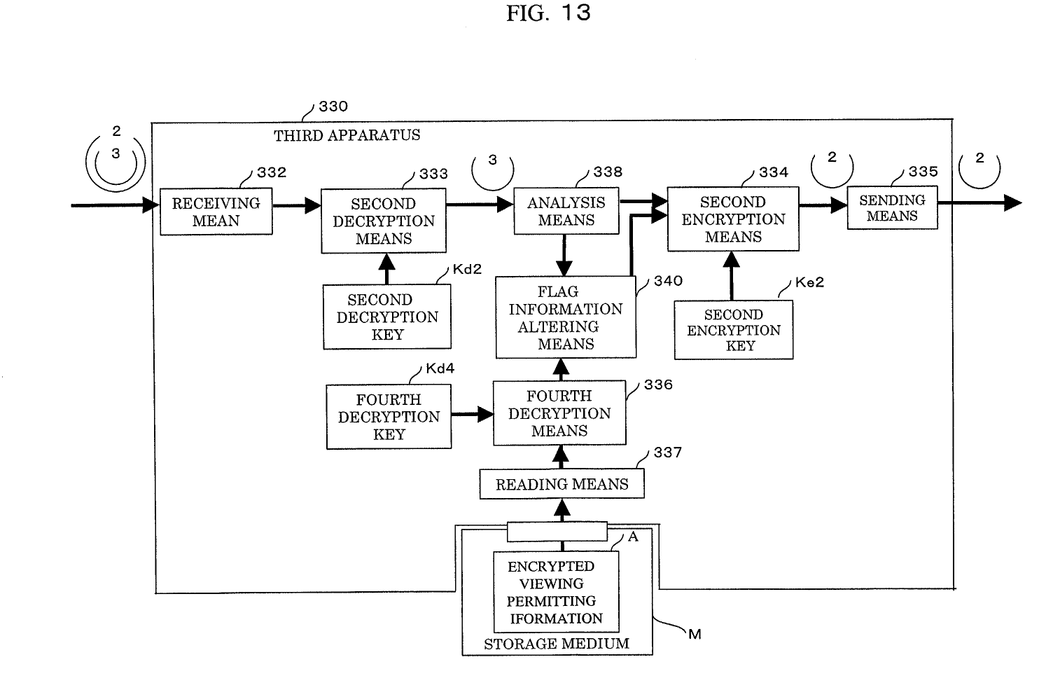

FIG. 13 is a schematic function diagram of the third apparatus 330 in the present embodiment. The arrangement will be described limiting to the points different from those in Embodiment 5. The first apparatus 310 and second apparatus 320 are identical with those in Embodiment 5 and will not be described in detail.

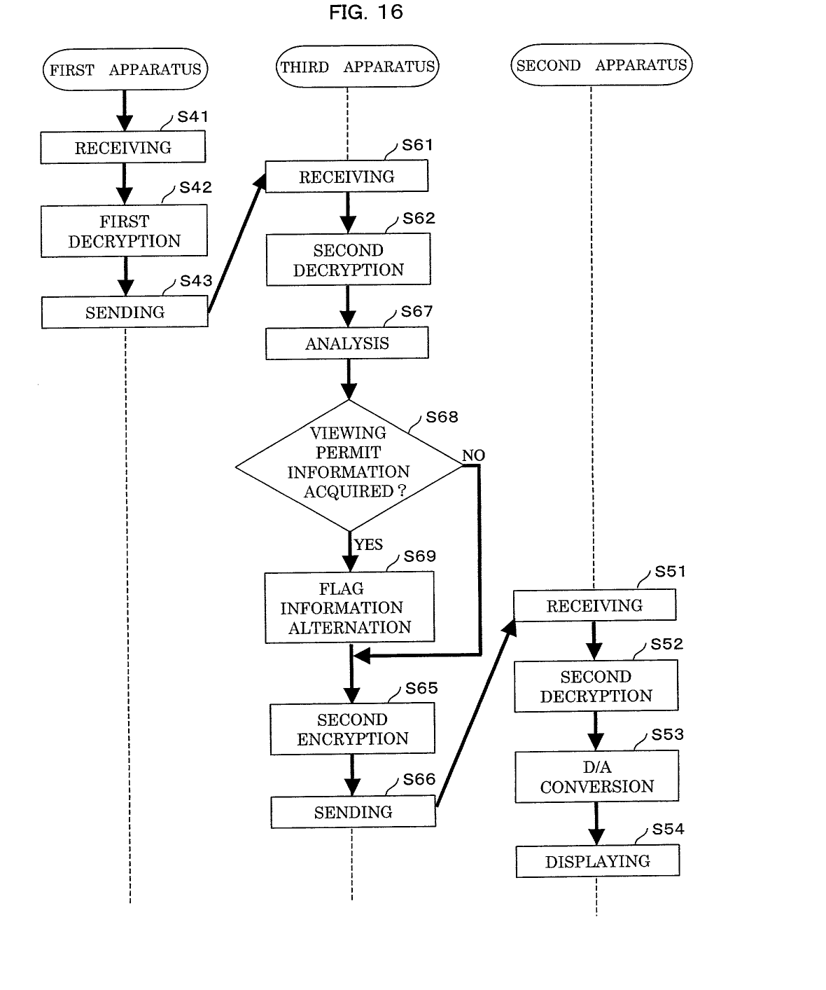

First, the data passed on to the sending means 313 in the first apparatus 310 in the same procedure as in Embodiment 5 is already encrypted by the second encryption method, and will be inputted into the second decryption means 333 through the receiving means 332 in third apparatus 330 (FIG. 16, Steps S 41→S 42→S 43→S61). Hereby, the second decryption means 333 decrypts the data using second decryption key Kd2 (FIG. 16, Step S 62) and then refers this decrypted data to the analysis means 338.

The data that is passed on to analysis means 338 is separated into contents, viewing limit flag information and other information which will be described hereunder (contents agent information, for example) (FIG. 16, Step S 67). And viewing limit flag information is inputted into the third decryption means 331 while other information (that is, contents and other information) is inputted into the second encryption means 334.

The term “viewing limit flag information” is information indicating whether it is possible to view the content. For example, if the viewing limit flag information is set to “1,” it indicates that it is possible to view the contents. Hereunder, therefore, such viewing limit flag information shall be called “viewable flag information.”

On the other hand, if viewing limit flag information is set to “0,” it means that the viewing of the contents is prohibited. Hereunder, therefore, such viewing limit flag information shall be called “viewing prohibiting flag information.”

Now, if the storage medium M is inserted into the third apparatus 330, the reading means 337, which detects that, reads “viewing permitting information A encrypted by the fourth encryption method” stored in storage medium M and passes the information on to the fourth decryption means 336. Hereby, the fourth decryption means 336 decrypts “viewing permitting information A encrypted by the fourth encryption method” using fourth decryption key Kd4 and passes this viewing permitting information A to flag information altering means 340.

Now, viewing limit flag information extracted from data by the analysis means 338 and viewing permitting information A decrypted by the fourth decryption means 336 have been inputted into flag information altering means 340. Then, in case the viewing limit flag information is viewing prohibiting flag information, flag information altering means 340 alters this viewing prohibiting flag information into viewable flag information and passes this information on to second encryption means 334.

Viewing permitting information A read from the storage medium M as mentioned above is viewing permitting information A offered by the contents agent but is not always viewing permitting information A for the contents.

That is, if viewing permitting information A read from the storage medium M is viewing permitting information A for the contents, viewing prohibiting flag information is altered into viewable flag information and inputted into second encryption means 334 (FIG. 16, Step S 68: YES→S69). On the other hand, viewing permitting information A read from storage medium M is not viewing permitting information A for the contents, viewing prohibiting flag information will be inputted into the second encryption means 334 without being altered (FIG. 16, Step S 68: NO).

Now, if viewing limit flag information is inputted into the second encryption means 334 from the flag information altering means 340 as mentioned above, the second encryption means 334 combines contents and other information inputted from the analysis means 338 and viewing limit flag information inputted from the flag information altering means 340. And the combined data thus obtained is encrypted using second encryption key Ke2, and then this encrypted data is passed on to the sending means 335 (FIG. 16, Steps S 65→S 66).

After data is sent to second apparatus 320 by sending means 335, the contents will be displayed on display means 324 in second apparatus 320 or not be normally displayed. This is the same as in Embodiment 1 (FIG. 16, Steps S 51→S 52→S 53→S 54).

In the present embodiment, as described above, the flag information altering means 340 which functions as third decryption means 331 is provided in the third apparatus 330. Hereby, each contents agent can offer the third apparatus 330 provided with the use limit using its own means or its own algorithm. In the present embodiment, needless to say, it is also possible to connect the first apparatus 310 and the second apparatus 320 via a plurality of the third apparatuses 330.

The above description shows an example where third decryption key Kd3 or viewing permitting information A is stored in storage medium M and distributed, but the distribution of third decryption key Kd3 or the like is not limited to that arrangement. For example, the viewer himself or herself may input third decryption key Kd3 or the like using operating means (not shown) (bar code reader, fingerprint identifier etc.), or third decryption key Kd3 or the like may be embedded in incidental information of data. The same results can be obtained.

In the foregoing description, encryption methods are distinguished using the terms first to fourth. But it is not always necessary that the methods are different from each other. For example, even if the second and fourth encryption methods are identical, the present invention will produce the same results.

Furthermore, while no mention is made in the foregoing description in particular, the values of decryption key and encryption key may be fixed or variable. Needless to say, if the values are variable, it is necessary to have a means to change the values of a decryption key and encryption key, but such technique is well known and not the object of the present invention, and will not be explained in detail here.

In the foregoing description, in addition, the flow of data is from first apparatus 310 to second apparatus 320, but the present invention is not limited to that. For authentication of equipment, for example, two way communication has to be possible. A reverse path (that is, a path toward first apparatus 310) may be provided within third apparatus 330.

Furthermore, in the foregoing description, limitation of viewing of contents is shown by way of example. The present invention is not limited to that. In examples where contents are used where the expression “viewing” does not fit (printing of contents, for example), the present invention can produce the same results.

Furthermore, the contents is not a TV program but may be confidential information that can be disclosed to a specific person only.

As set forth above, if the use limit of contents and physical features for removal of the use limit of contents are used, the problems with the prior art will not be encountered. With the prior art, it can happen that the user forgets the decryption key and can not use contents.

It can also happen that a third party steals the IC card in which the decryption key is stored and uses contents.

As long as each contents agent follows specific rules, the agent can offer a third apparatus provided with the use limit using its own means or its own algorithm. That is, each agent itself can decide what kind or intensity of encryption method should be adopted as third encryption method, or whether the third decryption should be encrypted or not.

In the third apparatus to which the present invention is applied, furthermore, the following rules are prescribed. That is, inputted data is decrypted by the second decryption means 333, and data to be outputted is encrypted by the second encryption means 333.

Therefore, it is possible to connect the first apparatus and the second apparatus via a plurality of the third apparatuses.

What is claimed is:

1. A sending apparatus in a transmission system confirming that use permit information included in contents is identical with use permit information in a receiver and making it possible to use said contents, said sending apparatus comprising:
storage means for storing physical features of a contents user as said use permit information and
multiplexing means for multiplexing said physical features and contents.

2. The sending apparatus of claim 1 which further comprises scrambling means for scrambling said contents.

3. The sending apparatus of claim 1 which further comprises encryption means for encrypting said physical features.

4. The sending apparatus of claim 1 wherein said physical features include at least one of fingerprint, palm print, hand print, voiceprint, pattern of the retina, pattern of the iris, form of the face, and DNA (deoxyribo nucleic acid).

5. A receiving apparatus which comprises:
receiving means for receiving multiplexed information in which the physical features of a contents user and contents are multiplexed,
acquiring means for acquiring the physical features of the content user included in said multiplexed information,
judging means for judging whether the physical features of said contents user acquired by said acquiring means are identical with the physical features of a contents user received by said receiving means, and
removal means that makes it possible to use contents included in multiplexed information received by said receiving means if said judging means judges that the physical features are identical.

6. The receiving apparatus of claim 5 which further comprises removal means for descrambling contents if the contents included in said multiplexed information is scrambled.

7. The receiving apparatus of claim 5 which further comprises decryption means for decrypting physical features if the physical features of a contents user included in said multiplexed information is encrypted.

8. The receiving apparatus of claim 5 which further comprises a feature reader for reading the physical features of said contents user, said reader being fixable on and detachable from said acquiring means.

9. The receiving apparatus of claim 5 wherein said physical features include at least one of fingerprint, palm print, hand print, voiceprint, pattern of the retina, pattern of the iris, form of the face, and DNA.

10. A receiving apparatus which comprises:
storage means storing the physical features of a contents user as use permit information,
a sending apparatus comprising multiplexing means for multiplexing said physical features and contents,
receiving means for receiving multiplexed information where said physical features and contents are multiplexed,
acquiring means for acquiring the physical features of a contents user,
judging means for judging whether the physical features of said contents user acquired by said acquiring means are identical with the physical features of a contents user received by said receiving means, and
removal means that makes it possible to use contents included in multiplexed information received by said receiving means if said judging means judges that the physical features are identical.

11. A contents sending method used in a transmission system confirming that use permit information included in contents is identical with use permit information in a receiver and making it possible to use said contents, said sending method comprising the steps of:
scrambling contents and
multiplexing said physical features and scrambled contents.

12. A receiving apparatus in a system handling contents provided with a use limit for the transmission, a use limit for the reproduction and a use limit for contents, said receiving apparatus comprises:
reading means for reading a removal key to remove the use limit for the contents when contents with the use limit for the transmission removed is obtained, and
removal means for removing the use limit for the contents using the removal key read by said reading means, and transferring the contents to an apparatus where the contents is used.

13. The receiving apparatus of claim 12 which further comprises reading means for reading removal information from a storage medium and inputting the information into said removal means.

14. The receiving apparatus of claim 12 which further comprises operating means for inputting removal information into said removal means.

15. The receiving apparatus of claim 13 or claim 14 which further comprises removal information decryption means for decrypting removal information if the removal information is encrypted.

16. The receiving apparatus of claim 12 wherein said removal means is flag information altering means for converting use prohibiting flag information set on contents into use permitting flag information.

17. The receiving apparatus of claim 12 wherein said removal means is contents decryption means for decrypting encrypted contents.

18. A use limit system handling contents provided with a use limit the transmission, a use limit for the reproduction and a use limit for contents, said use limit system comprises:
first apparatus for removing a use limit for transmission,
third apparatus for removing a use limit for contents when the contents with the use limit for the transmission removed is obtained, and
second apparatus for removing a use limit for the reproduction when the contents with a use limit for contents is removed.

19. The use limit system of claim 18 wherein after removing a use limit for the reproduction, said third apparatus sets a use limit for the reproduction.

20. The use limit system of claim 18 or 19 wherein said first apparatus and said second apparatus are connected via a plurality of said third apparatuses.
